(19) United States
(12) Patent Application Publication
(10) Pub. No.: US 2026/0273494 A1
(43) Pub. Date: Sep. 17, 2026

(54) ATTOLITER DROPLET-BASED, ELECTROCHEMICAL PARALLEL DNA SYNTHESIZER AND DNA SYNTHESIS METHOD USING SAME

(71) Applicant: KOREA UNIVERSITY RESEARCH AND BUSINESS FOUNDATION, Seoul (KR)

(72) Inventor: Hong Gu CHUN, Seoul (KR)

(73) Assignee: KOREA UNIVERSITY RESEARCH AND BUSINESS FOUNDATION, Seoul (KR)

(21) Appl. No.: 19/163,035

(22) PCT Filed: Mar. 11, 2024
(86) PCT No.: PCT/KR2024/003086

§ 371 Date: Sep. 8, 2025

(30) Foreign Application Priority Data
Mar. 10, 2023 (KR) 10-2023-0032123

(51) Int. Cl. B01J 19/00

(52) U.S. Cl. CPC B01J 19/0046; B01J 2219/00317; B01J 2219/00353; B01J 2219/00585; B01J 2219/00653; B01J 2219/00722

(57) ABSTRACT

The present invention relates to a nanowell array for electrochemical DNA synthesis and a DNA synthesis method using same. By utilizing the nanowell array, the consumption of samples in the electrochemical DNA synthesis process can be reduced, and the diffusion of hydrogen ions can be prevented, thereby reducing synthesis errors.

### TECHNICAL FIELD

The present invention relates to a nanowell array for electrochemical DNA synthesis, an attoliter droplet-based electrochemical parallel DNA synthesizer including the nanowell array, and a DNA synthesis method using the same.

### BACKGROUND ART

The growth of personal social network services (SNS), which primarily focus on images and videos, has rapidly increased the data generation volume. The data volume is expected to increase more drastically as 3D media such as augmented reality (AR), virtual reality (VR), mixed reality (MR), and holograms become widespread. Specifically, the amount of data stored globally by 2040 is projected to reach 10²⁴ to 10²⁹ bits (Summary report, Technology Working Group Meeting on Future DNA Synthesis Technologies (Sept. 14, 2017, Arlington, VA)).

Currently, the data storage medium for major devices such as computers and smartphones is a flash memory, which has a data density of approximately 1 bit per picogram (pg). To supply the flash memory needed for the data volume in 2040, 10¹⁴ kg of silicon wafers would be required. However, the silicon wafer supply in 2040 is projected to be around 10⁸ kg, falling far short of demand. Furthermore, existing data storage media have a limited data retention period of approximately 10 years.

Accordingly, efforts are continuously being made to develop new data storage media, one of which is DNA storage devices. Using DNA as a storage medium can overcome the data storage density limitations of existing storage media and ensure stable information storage even under physical shocks. Furthermore, synthesis of just 1 kg of DNA may enable the storage of 2×10²⁴ bits (equivalent to 10⁹ kg of flash memories), making it suitable for large-capacity data storage. In particular, DNA has the advantage of very long data retention periods. However, errors occurring during DNA synthesis may reduce data storage density and cause information loss, hindering the commercialization of DNA storage devices.

### DISCLOSURE

### Technical Problem

Under the above-described circumstances, the present inventors conducted research to improve synthesis errors caused by diffusion of hydrogen ions during a DNA deprotection process when synthesizing DNA by an electrochemical method and to reduce synthesis costs and confirmed that the above-described problem may be addressed by using a nanowell array including an electrode inside the nanowell.

Accordingly, an object of the present invention is to provide a nanowell array for electrochemical DNA synthesis, a DNA synthesis device including the nanowell array, and a DNA synthesis method using the nanowell array.

### Technical Solution

To achieve the above-described object, one aspect of the present invention provides a nanowell array for DNA synthesis including the following structure:
a substrate portion having a plurality of nanowells formed therein, each having a diameter and a depth of less than 1 μm; and an electrode portion positioned horizontally or vertically with respect to a bottom of the nanowell and including a first electrode and a second electrode.

Another aspect of the present invention provides a nanowell array for DNA synthesis including the following structure:
a substrate portion having a plurality of nanowells formed therein, each having a diameter and a depth of less than 1 μm; and an electrode portion positioned horizontally or vertically with respect to a bottom of the nanowell and including a first electrode, a second electrode, and a reference electrode.

In addition, the present invention provides a DNA synthesis device for parallel DNA synthesis including the following configuration:
a power supply portion for supplying power to the nanowell array;
a fluid supply portion for supplying a DNA synthesis site selection solution containing a reduction material to the nanowell array; and
a pump portion for removing the solution supplied to the nanowell array.

The present invention provides a DNA synthesis method using the nanowell array, including the following steps:
a) a step of supplying a DNA synthesis site selection solution containing a reduction material to the nanowell array;
b-1) a step of applying, when an electrode portion of the nanowell array includes a first electrode and a second electrode, a first voltage waveform to the first electrode relative to the second electrode to generate hydrogen ions in the DNA synthesis site selection solution; or
b-2) a step of applying, when an electrode portion of the nanowell array includes a first electrode, a second electrode, and a reference electrode, a first voltage waveform to the first electrode relative to the reference electrode to generate hydrogen ions in the DNA synthesis site selection solution; and
c) a step of supplying a solution including a nucleotide to be synthesized.

### Advantageous Effects

By using a nanowell array for DNA synthesis according to one example of the present invention, the amount of sample consumed in an electrochemical DNA synthesis process can be reduced, and the diffusion of hydrogen ions can also be prevented, thereby reducing synthesis errors.

### DESCRIPTION OF DRAWINGS

FIG. 1 shows a cross-section of a nanowell array for DNA synthesis according to one example of the present invention.

FIG. 2 shows a cross-section of a nanowell array including a cover portion and a sealing portion according to one example of the present invention.

FIG. 3 shows a structure of an electrode portion including two electrodes in a nanowell array as observed from the top of a nanowell.

FIG. 4 shows a structure of an electrode portion including three electrodes in a nanowell array as observed from the top of a nanowell.

FIG. 5 shows a diagram schematically illustrating a process of synthesizing DNA using a nanowell array.

FIG. 6 shows a diagram schematically illustrating a process of blocking a nanowell by supplying a pressure transmitting fluid between a cover portion and a sealing portion of a nanowell array.

### MODES OF THE INVENTION

Hereinafter, with reference to the attached drawings, preferred embodiments are described in detail so that a person having ordinary skill in the art to which the present invention pertains may easily implement the present invention. However, in the description of the preferred embodiments of present invention, when it is determined that the detailed description of a related function or feature known in the art would obscure the gist of the present invention, the description thereof will be omitted. In addition, parts with similar functions and actions are designated by the same reference numerals throughout the drawings. Meanwhile, when ‘including’ a certain component is stated, unless specified otherwise, this means that other components may be further included, rather than other components are excluded.

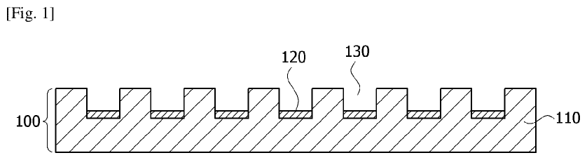

FIG. 1 shows a cross-section of a nanowell array for DNA synthesis according to one example of the present invention. The nanowell array may be used for electrochemical DNA synthesis.

Conventional electrochemical DNA synthesis arrays synthesize DNA at microelectrodes. To selectively deprotect the 5′-end of DNA protected by a protecting group such as 4,4′-dimethoxytrityl (DMT) group, a positive voltage is applied to the electrode, locally generating H⁺ ions. However, H⁺ ions diffuse very rapidly and may quickly reach adjacent electrodes, thereby deprotecting DNA at undesirable positions and potentially causing synthesis errors. The present invention was designed to address this issue.

As illustrated in FIG. 1, the nanowell array 100 of the present invention includes a substrate portion 110 in which a plurality of nanowells 130 are formed, each having a diameter and a depth of less than 1 μm; and an electrode portion 120 positioned horizontally or vertically with respect to a bottom of the nanowell.

In the present invention, the substrate portion 110 may be made of a material selected from the group consisting of silicon, silicon nitride, silicon oxide, glass, and quartz, but is not limited thereto.

In the present invention, a plurality of nanowells 130 may be formed in the substrate portion, and the diameter and the depth thereof may be 10 nm or more and less than 1 μm. By using nanowells with the above-described size, the volume of the nanowell may be reduced to 1 attoliter (10⁻¹⁸ liter) or less, and as a result, the integration of DNA synthesis in the nanowell array can be greatly increased and sample consumption can be reduced.

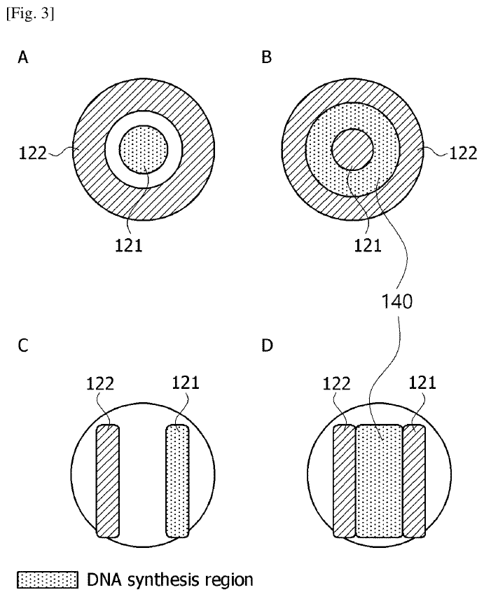

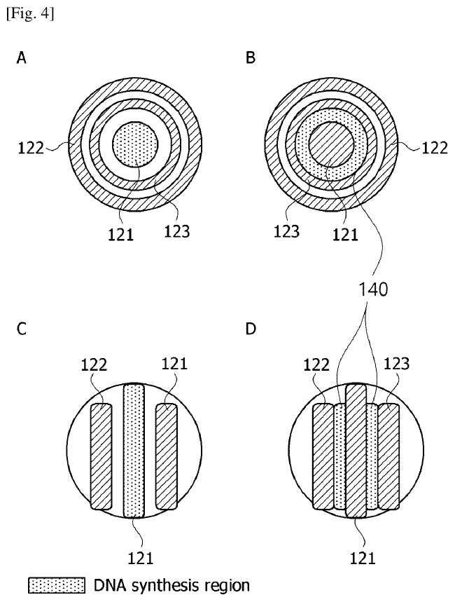

The nanowell array 100 of the present invention may include two or three electrodes in the electrode portion 120. Specifically, as illustrated in FIG. 3, the electrode portion 120 includes a first electrode 121 and a second electrode 122. FIG. 4 illustrates an electrode portion 120 including a first electrode 121, a second electrode 122, and a reference electrode 123.

The first electrode 121 and first second electrode 122 may be made of a material selected from the group consisting of gold (Au), aluminum (Al), titanium (Ti), copper (Cu), and platinum (Pt).

The first electrode 121 and the second electrode 122 are positioned horizontally or vertically with respect to a bottom of the nanowell. When they are horizontal with respect to the bottom of the nanowell, they may be positioned in contact with the bottom of the nanowell. When they are vertical with respect to the bottom of the nanowell, they may be positioned in contact with a side surface of the nanowell, or they may be positioned vertically with respect to an inner space of the nanowell.

The first electrode and the second electrode serve to induce electrochemical reactions in the solution within the nanowell, specifically, induce oxidation and reduction reactions. Specific details are described in the DNA synthesis method below.

The reference electrode 123 has the meaning commonly used in the field of electrochemistry and specifically serves as a reference point for the voltage of the first electrode in the solution.

The reference electrode 123 is preferably made of a different material from the first electrode 121 and the first second electrode 122, and may be, for example, an Ag/AgCl electrode or a platinum black electrode.

FIGS. 3 and 4 show the shape of the electrode portion. Specifically, the electrode portion may have a concentric circle shape in which the first electrode is positioned inside, and the second electrode is positioned outside the first electrode. When there are three electrodes, the electrode portion may have a concentric circle shape in which the first electrode is positioned inside, the reference electrode is positioned outside the first electrode, and the second electrode is positioned outside the reference electrode.

Meanwhile, FIGS. 3 and 4 show the position of a DNA synthesis portion 140. As shown in FIG. 3, the nanowell array 100 of the present invention may further include a DNA synthesis portion 140 in which DNA synthesis occurs at the first electrode 121 or between the first electrode and the second electrode. In addition, as shown in FIG. 4, when the electrode portion 120 includes three electrodes, DNA synthesis may occur at the first electrode 121 or a DNA synthesis portion 140 may be further included between the second electrode and the reference electrode, between the second electrode and the first electrode, or between the first electrode and the reference electrode.

The DNA synthesis portion 140 refers to a bottom surface of the nanowell exposed between the electrodes and may be made of a material selected from the group consisting of silicon, silicon nitride, silicon oxide, glass, and quartz, but is not limited thereto.

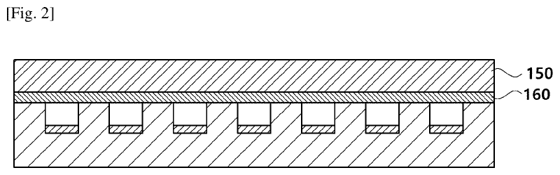

The nanowell array 100 of the present invention may further include a cover portion 150 positioned at an upper end of the array to block the nanowells and/or a sealing portion 160 to separate each nanowell, as illustrated in FIG. 2.

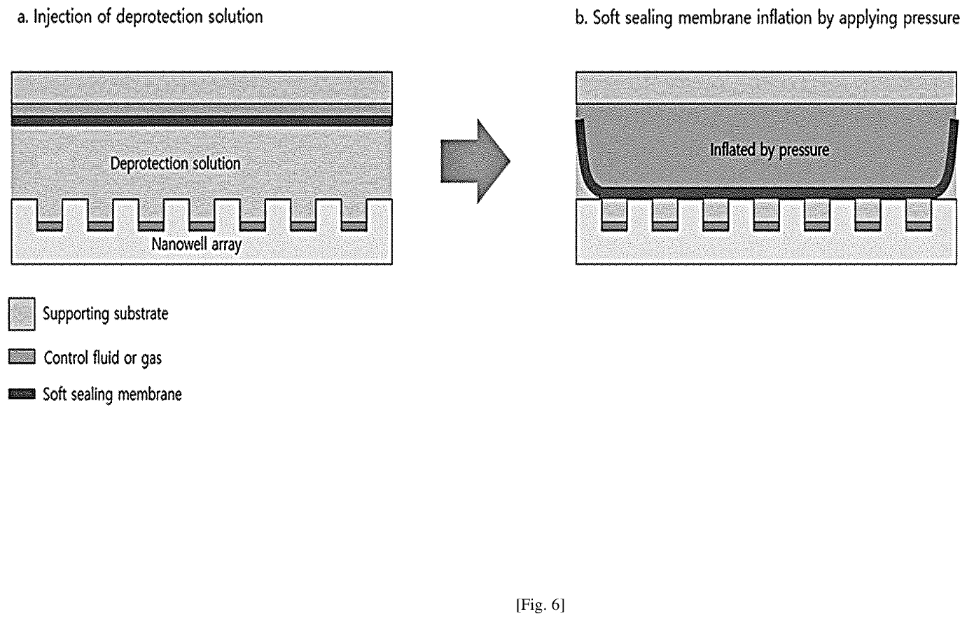

In FIG. 2, the sealing portion 160 is in contact with a lower end of the cover portion 150, but as shown in FIG. 6, it may be separately present from the cover portion so that a fluid may flow.

The cover portion 150 may be made of a material selected from the group consisting of silicon, silicon nitride, silicon oxide, glass, and quartz, but is not limited thereto.

The sealing portion 160 may be made of a material selected from the group consisting of Teflon, polydimethylsiloxane (PDMS), and polyester, and an example of the polyester material is a Mylar® polyester film.

The cover portion 150 is in close contact with an upper end of the nanowell array 100 to confine the solution supplied to the array inside the nanowell 130 or to prevent hydrogen ions generated in one nanowell from flowing to another nanowell during DNA synthesis.

The sealing portion 160 also performs a similar function to the cover portion 150. Additionally, since the sealing portion 160 is made of a more flexible material than the cover portion 150, a fluid may be supplied between the cover portion and the sealing portion to expand the sealing portion so that the solution is partitioned into droplets of extremely small volume in each nanowell. A specific example is illustrated in FIG. 6.

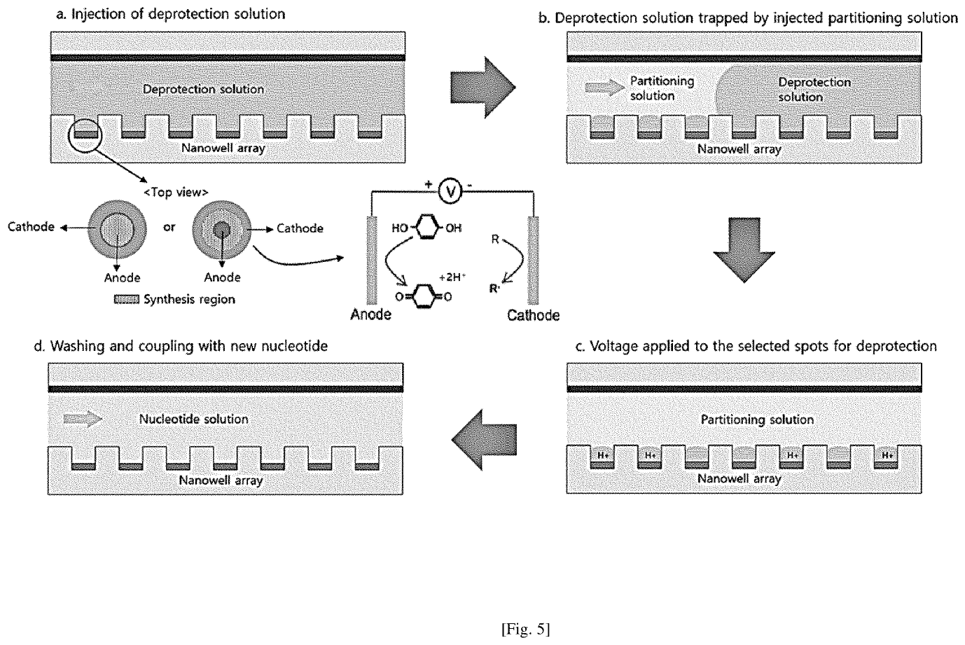

FIG. 5 shows a diagram schematically illustrating a process of synthesizing DNA using a nanowell array. The method includes the following steps:
a) a step of supplying a DNA synthesis site selection solution containing a reduction material to the nanowell array;
b-1) a step of applying, when an electrode portion of the nanowell array includes a first electrode and a second electrode, a first voltage waveform to the first electrode relative to the second electrode to generate hydrogen ions in the DNA synthesis site selection solution; or
b-2) a step of applying, when an electrode portion of the nanowell array includes a first electrode, a second electrode, and a reference electrode, a first voltage waveform to the first electrode relative to the reference electrode to generate hydrogen ions in the DNA synthesis site selection solution; and
c) a step of supplying a solution including a nucleotide to be synthesized.

The method begins with a step of supplying a DNA synthesis site selection solution containing a reduction material to a nanowell array. The supply may be accomplished through a microfluidic tube connected to the nanowell array.

In the present invention, the term ‘DNA synthesis site selection solution’ refers to a solution in which a reduction material necessary for synthesizing DNA only at a preferred position during a DNA synthesis process is dissolved. Reduction materials that may be used include Co³⁺, S₂O₈²⁻, Ce⁴⁺, and the like but are not limited thereto. The reduction material is a substance that is reduced before OH-is generated at the second electrode while H+ is generated at the first electrode, and increases H+ inside the nanowell, thereby allowing the protecting group at the 5′ end of DNA to be removed.

In the present invention, the DNA synthesis site selection solution of Step a) may further contain an oxidation material. Oxidation materials that may be used as a material exposing the 5′-end of DNA include K, Ca, and the like but are not limited thereto. The oxidation material is a material that generates hydrogen ions by voltage application and/or is oxidized so that H+ is not generated while OH is generated.

The purpose of using the reduction material and the oxidation material is to prevent H+ inside the nanowell from entering and affecting an adjacent nanowell when the cover is opened for washing after DNA coupling.

Specifically, when a second voltage waveform is applied to generate OH⁻ inside a nanowell, OH⁻ will meet H⁺ and be neutralized. When a reduction material already included in the DNA synthesis site selection solution has been completely consumed, OH⁻ will be generated even when the first voltage waveform is maintained for a certain period of time, but H⁺ may still be generated. Therefore, it is preferable that the second voltage waveform is a higher voltage than the first voltage waveform. At this time, even when OH⁻ is generated, it is meaningless when H⁺ is also generated, so when more oxidation material is included, it will start to be oxidized at a higher voltage, so even when H⁺ is generated, the rate will decrease, and the amount of OH⁻ generated will ultimately be greater, thereby neutralizing the inside of the nanowell.

When only a reduction material is included in the DNA synthesis site selection solution, a protecting group attached to an end of the DNA being synthesized may be directly removed by voltage application.

When an oxidation material and a reduction material are included in the DNA synthesis site selection solution, the protecting group attached to an end of the DNA being synthesized may be directly removed by voltage application, and the protecting group may also be removed by the generated hydrogen ions (H⁺).

The method may further include, after Step a):
a step of supplying a partitioning solution to the nanowell array to confine the DNA synthesis site selection solution to the nanowell;
a step of sealing an upper end of the nanowell array with a cover portion to confine the DNA synthesis site selection solution to the nanowell; or
a step of sealing an upper end of the nanowell array with a sealing portion to confine the DNA synthesis site selection solution to the nanowell.

The method may further include, after Step c), a step of supplying a solution containing a DNA protecting group and a step of washing the nanowell array.

This additional step is a step to confine the DNA synthesis site selection solution to each nanowell, thereby preventing the hydrogen ions generated in the DNA synthesis site selection solution from diffusing to another nanowell. This step may be performed by sealing an upper end of the nanowell array with a cover portion or a sealing portion as described above or by supplying a fluid between the cover portion and the sealing portion to expand the sealing portion.

The partitioning solution preferably has a contact angle of 90 degrees or more with an inner surface of the nanowell and a contact angle of 90 degrees or less with a substrate surface excluding the inner surface of the nanowell. Conversely, the DNA synthesis site selection solution preferably has a contact angle of 90 degrees or less with the inner surface of the nanowell.

Since the contact angles of the partitioning solution and the DNA synthesis site selection solution are different, the two solutions do not mix, so the partitioning solution may confine the DNA synthesis site selection solution to the nanowell.

The DNA synthesis site selection solution may further include a protecting group (DNA synthesis site selection substance) that may bind to the 5′-end of the coupled DNA. This protecting group may bind to a divalent cation or hydrogen ion that affects the efficiency of DNA synthesis. In addition, the DNA synthesis site selection solution may further include a molecule that generates a divalent cation by the first voltage waveform. The divalent cation may be selected from the group consisting of Co²+, Zn²⁺, and Mn²⁺ but is not limited thereto.

Meanwhile, Step b-1) or b-2) may be a step in which hydrogen ions are generated in the DNA synthesis site selection solution while reducing the reduction material at the second electrode, but a redox voltage of the reduction material is higher than a reduction voltage at which one of the molecules present in the DNA synthesis site selection solution is reduced to generate hydroxide ions, so that hydroxide ions are not generated in the DNA synthesis site selection solution.

When hydrogen ions are generated in the DNA synthesis site selection solution while hydroxide ions are generated from the reduction material, the hydrogen ions are neutralized and DNA deprotection does not occur. Therefore, the present inventors designed this step so that hydroxide ions are not generated.

The DNA synthesis method of the present invention may further include, after Step b):
d-1) a step of applying a second voltage waveform to the first electrode of the nanowell array relative to the second electrode after Step b-1) to generate hydroxide ions at the first electrode or the second electrode; or
d-2) a step of applying a second voltage waveform to the first electrode of the nanowell array relative to the reference electrode after Step b-2) to generate hydroxide ions at the first electrode or the second electrode.

The names Step d-1) and Step d-2) are merely intended to distinguish each step and do not indicate the order of the steps.

Steps d-1) and d-2) are steps in which, after generating hydrogen ions in Steps b-1) and b-2) so that DNA is coupled to a desired position, hydroxide ions are generated to prevent the hydrogen ions from diffusing to another nanowell.

The DNA synthesis method of the present invention further includes a step of removing the DNA synthesis site selection solution after Steps d-1) and d-2). The removal may be accomplished by a method such as suction through a microfluidic tube, and a process of washing the nanowell array may also be performed to completely remove the DNA synthesis site selection solution.

In the description of the present DNA synthesis method, the first voltage waveform and the second voltage waveform refer to the order of voltages applied to electrodes, and the waveforms may be DC voltages or may move linearly or stepwise between two or more voltage values.

Meanwhile, while a DNA synthesis method based on an electrochemical method is described above, the nanowell array of the present invention may also be used for DNA synthesis using DNA polymerase. In this case, as described above, the DNA synthesis site selection solution includes a molecule that generates a divalent cation in response to a first voltage waveform.

In addition, the present invention provides a DNA synthesis device including the following:
a nanowell array;
a power supply portion for supplying power to the nanowell array;
a fluid supply portion for supplying a DNA synthesis site selection solution containing a reduction material to the nanowell array; and
a pump portion for removing the solution supplied to the nanowell array.

The nanowell array and the DNA synthesis site selection solution are the same as described above.

In the present invention, the power supply portion may be configured as an active matrix complementary metal-oxide-semiconductor (CMOS) circuit.

The fluid supply portion may supply a DNA synthesis site selection solution including an oxidation material and a reduction material.

The DNA synthesis device may further include a fluid tube connecting the nanowell array and the fluid supply portion and connecting the nanowell array and the pump portion.

### REFERENCE NUMERALS

100: nanowell array;
110: substrate portion;
120: electrode portion;
121: first electrode;
122: second electrode;
123: reference electrode;
130: nanowell;
140: DNA synthesis portion;
150: cover portion; and
160: sealing portion.

1. A nanowell array for DNA synthesis, comprising:
a substrate portion having a plurality of nanowells formed therein, each having a diameter and a depth of less than 1 μm; and
an electrode portion positioned horizontally or vertically with respect to a bottom of the nanowell and including a first electrode and a second electrode.

2. The nanowell array of claim 1, further comprising a DNA synthesis portion between the first electrode and the second electrode.

3. A nanowell array for DNA synthesis, comprising:
a substrate portion having a plurality of nanowells formed therein, each having a diameter and a depth of less than 1 μm; and
an electrode portion positioned horizontally or vertically with respect to a bottom of the nanowell and including a first electrode, a second electrode, and a reference electrode.

4. The nanowell array of claim 3, further comprising a DNA synthesis portion between the second electrode and the reference electrode, between the second electrode and the first electrode, or between the first electrode and the reference electrode.

5. The nanowell array of claim 1, further comprising a cover portion positioned at an upper end of the array to block the nanowell.

6. The nanowell array of claim 5, wherein the cover portion further includes a sealing portion that separates each nanowell at a lower end therein.

7. The nanowell array of claim 6, wherein the sealing portion is made of a material selected from the group consisting of Teflon, polydimethylsiloxane (PDMS), and polyester.

8. The nanowell array of claim 1, wherein the first electrode and the second electrode are made of a material selected from the group consisting of gold (Au), aluminum (Al), titanium (Ti), copper (Cu), and platinum (Pt).

9. The nanowell array of claim 1, wherein the electrode portion has a concentric circle shape in which the first electrode is positioned inside and the second electrode is positioned outside the first electrode.

10. The nanowell array of claim 3, wherein the electrode portion has a concentric circle shape in which the first electrode is positioned inside, the reference electrode is positioned outside the first electrode, and the second electrode is positioned outside the reference electrode.

11. A DNA synthesis device for parallel DNA synthesis, comprising:
the nanowell array of claim 1, in which DNA synthesis occurs;
a power supply portion for supplying power to the nanowell array;
a fluid supply portion for supplying a DNA synthesis site selection solution containing a reduction material to the nanowell array; and
a pump portion for removing the solution supplied to the nanowell array.

12. A DNA synthesis method using the nanowell array of comprising:
a) a step of supplying a DNA synthesis site selection solution containing a reduction material to the nanowell array;
b-1) a step of applying, when an electrode portion of the nanowell array includes a first electrode and a second electrode, a first voltage waveform to the first electrode relative to the second electrode to generate hydrogen ions in the DNA synthesis site selection solution; or
b-2) a step of applying, when an electrode portion of the nanowell array includes a first electrode, a second electrode, and a reference electrode, a first voltage waveform to the first electrode relative to the reference electrode to generate hydrogen ions in the DNA synthesis site selection solution; and
c) a step of supplying a solution including a nucleotide to be synthesized.

13. The method of claim 12, wherein the DNA synthesis site selection solution of Step a) further contains an oxidation material.

14. The method of claim 12, further comprising, after Step a):
a step of supplying a partitioning solution to the nanowell array to confine the DNA synthesis site selection solution to the nanowell;
a step of sealing an upper end of the nanowell array with a cover portion to confine the DNA synthesis site selection solution to the nanowell; or
a step of sealing an upper end of the nanowell array with a sealing portion to confine the DNA synthesis site selection solution to the nanowell.

15. The method of claim 12, further comprising, after Step b-1) or b-2, a step of removing the DNA synthesis site selection solution.

16. The method of claim 12, wherein Step b-1) or b-2) is a step in which hydrogen ions are generated in the DNA synthesis site selection solution at the first electrode while reducing the reduction material at the second electrode, but a redox voltage of the reduction material is higher than a reduction voltage at which any molecule present in the DNA synthesis site selection solution is reduced to generate hydroxide ions, so that hydroxide ions are not generated in the DNA synthesis site selection solution.

17. The method of claim 12, further comprising:
d-1) a step of applying a second voltage waveform to the first electrode of the nanowell array relative to the second electrode after Step b-1) to generate hydroxide ions at the first electrode or the second electrode; or
d-2) a step of applying a second voltage waveform to the first electrode of the nanowell array relative to the reference electrode after step b-2) to generate hydroxide ions at the first electrode or the second electrode.

18. The method of claim 17, wherein Step d-1) or Step d-2) is a step in which hydroxide ions are generated at the first electrode or the second electrode while oxidizing an oxidation material at an electrode other than the electrode at which hydroxide ions are generated, but an oxidation voltage of the oxidation material is higher than an oxidation voltage at which any molecule present in the DNA synthesis site selection solution is oxidized to generate hydrogen ions, so that the oxidation material is not oxidized when a first voltage waveform is applied in Step b-1) or b-2).
